(19) United States
(12) Patent Application Publication
(10) Pub. No.: US 2024/0243312 A1
(43) Pub. Date: Jul. 18, 2024

(54) Fuel Cell System and Control Method and Device Thereof

(71) Applicant: Robert Bosch GmbH, Stuttgart (DE)

(72) Inventors: Huixiang ZHANG, Wuxi (CN); Chengjun TAO, Wuxi (CN); Ren DONG, Wuxi (CN)

(21) Appl. No.: 18/404,341

(22) Filed: Jan. 4, 2024

(30) Foreign Application Priority Data
Jan. 13, 2023 (CN) 2023 1007 1564.3

(51) Int. Cl. H01M 8/04664; H01M 8/04223; H01M 8/04302; H01M 8/04537

(52) U.S. Cl. CPC H01M 8/04679; H01M 8/04268; H01M 8/04302; H01M 8/04649; H01M 2250/20

(57) ABSTRACT

A method for controlling a fuel cell system includes (i) performing a low-temperature start-up process of the fuel cell system, (ii) monitoring internal resistance of a fuel cell stack in the fuel cell system, and (iii) determining that the low-temperature start-up process of the fuel cell system is abnormal based on the appearance of an inflection point in the internal resistance of the monitored fuel cell stack.

This application claims priority under 35 U.S.C. § 119 to patent application no. CN 2023 1007 1564.3, filed on Jan. 13, 2023 in China, the disclosure of which is incorporated herein by reference in its entirety.

The present disclosure generally relates to a fuel cell system, and more particularly, to a control method and device in a low-temperature start-up process of a fuel cell system.

### BACKGROUND

In recent years, fuel cell vehicles have received increased attention as compared to conventional internal combustion engine vehicles due to their high energy conversion efficiency and the advantage of zero pollution emission. Proton-exchange membrane fuel cells, being developed as commercial fuel cells, have the advantage of low operating temperatures, fast load tracking, and safe and reliable operation, and are particularly well-suited for disclosure in fuel cell vehicles.

The low-temperature start-up process is carried out when a fuel cell is started up at a low temperature below the ice point. In the low-temperature start-up process, the heat generated from the power generation of the fuel cell may be used to gradually heat the fuel cell, or the heat generated by auxiliary equipment outside the fuel cell stack may be used to gradually heat the fuel cell, and the fuel cell system is in a normal operating status if the low-temperature start-up process is successfully completed. The low-temperature start-up process may fail due to a variety of possible reasons, such as ambient temperature, performance and status of the cell stack and associated assemblies, and the like.

Typically, cell voltage monitoring (CVM) is capable of reflecting the voltage status of a single cell or a group of cells in a cell stack. The voltage status detected by the CVM may be used to monitor the low-temperature start-up process and determine whether the low-temperature start-up is abnormal. However, the cost of CVM is high, and CVM is only capable of reflecting the voltage phenomenon during abnormal low-temperature start-up, i.e., abnormal cell voltage.

When a problem is diagnosed by the CVM, the cell stack may already be damaged, thereby affecting the life of the cell stack and associated assemblies.

### SUMMARY

The following introduction is provided in order to introduce selected concepts in a simple manner, and these concepts will be further described in the detailed description below. The introduction is not intended to highlight the key or necessary features of the claimed subject matter, nor is it intended to limit the scope of the claimed subject matter.

According to one aspect of the present disclosure, a method for controlling a fuel cell system comprising performing a low-temperature start-up process of the fuel cell system; monitoring internal resistance of a fuel cell stack in the fuel cell system; determining that the low-temperature start-up process of the fuel cell system is abnormal based on the appearance of an inflection point in the internal resistance of the monitored fuel cell stack from decrease to increase.

According to one aspect of the present disclosure, a device for controlling a fuel cell system is provided, the device comprising a control unit for controlling the operation of the fuel cell system by performing the method described in the various examples of the present disclosure.

According to an aspect of the present disclosure, a fuel cell system is provided, comprising a fuel cell stack; an internal resistance measurement unit for measuring the internal resistance of the fuel cell stack; and a control unit for controlling the operation of the fuel cell system by performing the method described in various examples of the present disclosure.

According to an aspect of the present disclosure, a mechanical device is provided, comprising a fuel cell system described in various examples of the present disclosure.

Using the method for controlling a fuel cell system according to the present disclosure, the failure of the low-temperature start-up process may be predicted ahead of time based on the moisture content and icing in the stack as reflected by the internal resistance of the fuel cell stack, effectively preventing or mitigating the damage of the cell stack. Other advantages of the examples of the present disclosure will be described below.

### BRIEF DESCRIPTION OF DRAWINGS

The nature and advantages of the content of the present disclosure may be further understood by referring to the following drawings. In the drawings, similar assemblies or features may have the same reference numerals.

FIG. 1 shows a block diagram of a fuel cell system according to an example.

FIGS. 2A-2C show a chart of changes in high-frequency resistance of a fuel cell stack according to an example, respectively.

FIG. 3 shows a flow chart of a method for controlling a fuel cell system according to an example.

FIG. 4 shows a block diagram of a mechanical device comprising a fuel cell system according to an example.

### DETAILED DESCRIPTION

The subject matter described herein will now be discussed with reference to exemplary embodiments. It should be understood that discussions about these embodiments are provided to aid those skilled in the art in better understanding and realization of the subject matter described herein rather than limiting the scope of protection, applicability, or examples described in the Claims. Changes may be made to the functions and arrangements of the elements discussed without departing from the scope of protection of the content of the present disclosure. Various processes or assemblies may be omitted, substituted, or added in the various examples as needed. For example, the described methods may be performed in a different order than that described, and various steps may be added, omitted, or combined. In addition, features described in relation to some examples may also be combined in other examples.

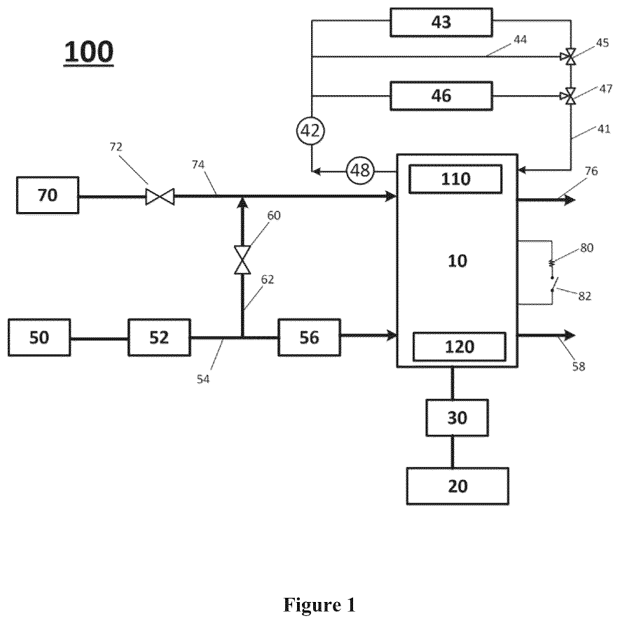

FIG. 1 shows a block diagram of a fuel cell system according to an example. In the example shown in FIG. 1, the fuel cell system 100 comprises a fuel cell stack 10. The fuel cell stack 10 is a stacked cell stack formed by stacking a plurality of fuel cells. A plurality of fuel cells are typically combined into one fuel cell stack to generate the desired power. For example, a fuel cell stack for a vehicle may comprise hundreds of stacked fuel cells. A single fuel cell comprises an anode (fuel pole), a cathode (oxidant pole), and an electrolyte membrane sandwiched between the cathode and the anode. In a fuel cell, anodic gas is supplied to the anode through, for example, an anodic gas channel between an anodic separator and the anode, cathodic gas is supplied to the cathode through a cathodic gas channel between the cathodic separator and the cathode, and power is generated by electrochemical reactions that occur using these gases at the anode and cathode. The major electrochemical reactions at the two electrodes, namely the anode and the cathode, at the time of power generation may be, for example, anode: 2H2→4H⁺4e⁻, cathode: 4H⁺4e⁻+O2→2H₂O.

The fuel cell may further comprise other structures, for example, it may comprise a coolant channel for coolant to flow through, and the coolant channel may be arranged in the cathodic separator and the anodic separator. It will be appreciated by those skilled in the art that the fuel cell stack and fuel cells therein are not limited to the structures described above, and embodiments of the present disclosure may be applied to a variety of fuel cells.

The fuel cell system 100 comprises a motor 50 and a compressor 52, where the motor 50 drives the compressor 52 through a cathodic gas inlet pipeline 54 to provide cathodic input gas flow, such as air, to the cell stack 10 and expel cathodic exhaust gas through a cathodic exhaust pipeline 58. In one example, cathodic gas inlet pipeline 54 may further comprise a moisture recovery unit 56 which recovers moisture from the cathodic exhaust gas of the cathodic exhaust pipeline 58 and uses the recovered moisture to humidify the cathodic gas in the cathodic gas inlet pipeline 54. An anodic gas source 70 provides anodic gas, such as hydrogen gas, to the anode of the fuel cell stack 10 through an anodic gas inlet pipeline 74, and anodic exhaust gas is expelled from the fuel cell stack 10 through an anodic exhaust pipeline 76.

During the shutdown of the fuel cell system 100, the cathodic and anodic flow channels in the fuel cell stack 10 are typically cleaned to remove excess water therein and a stack relative humidity that is suitable for the next fuel cell system start-up is provided. In the fuel cell system shown in FIG. 1, for the purpose of this shutdown cleaning, a cleaning valve 60 is provided in a cleaning pipeline 62 connecting the cathodic gas inlet pipeline 54 to the anodic gas inlet pipeline 74, such that air from the compressor 52 is directed to the cathodic and anodic flow channels in the fuel cell stack 10 when the cleaning valve 60 is open, and the anodic gas source 70 is closed through a valve 72 during the cleaning process. It will be appreciated by those skilled in the art that the implementation of the shutdown cleaning of a fuel cell system is not limited to the above described manners described with reference to FIG. 1. For example, the fuel cell system 1 may not comprise the cleaning pipeline 62 and the cleaning valve 60 therein as shown in FIG. 1. For the purpose of this shutdown cleaning, hydrogen gas is input at an anodic gas input port, while the amount of cathodic air input is adjusted and air inlet pressure is reduced to remove water in the cell stack. It will be appreciated by those skilled in the art that the technical solutions of the present disclosure are not limited to a particular method of cleaning.

The fuel cell stack 10 may further comprise a stack cooling system for controlling the temperature of the fuel cell stack 10, wherein comprising a cooling water circulation passage 41, a cooling water pump 42, a heat sink 43, a cooling water bypass passage 44, a three-way valve 45, a heater 46, a three-way valve 47, and a water temperature sensor 48. One end of the cooling water circulation passage 41 is connected to the cooling water inlet hole of the fuel cell stack 10 and the other end is connected to the cooling water outlet hole of the fuel cell stack 10. A cooling water pump 42 is disposed in the cooling water circulation passage 41 to supply cooling water to the fuel cell stack 10 via the heat sink 43. Further, the rotational speed of the cooling water pump 42 is controlled by a control unit 200. The heat sink 43 uses a fan, for example, to cool the cooling water being heated inside the fuel cell stack 10. The cooling water bypass passage 44 is a passage that bypasses the heat sink 43, returning the cooling water discharged from the fuel cell stack 10 to the fuel cell stack 10. The channels of the cooling water bypass passage 44 and the heat sink 43 are connected by a three-way valve 45, which is realized by a thermostat, for example, and the flow of cooling water bypassing the heat sink 43 is adjusted by adjusting the opening of the three-way valve 45. The heater 46 uses, for example, positive temperature coefficient (PTC) heaters to heat the cooling water. For example, cooling water is heated at the time of low-temperature start-up to aid in increasing the temperature of the cell stack with the heated cooling water. The cooling water bypass passage where the heater 46 is located is connected to the cooling water circulation passage 41 via the three-way valve 47, which is realized, for example, through a thermostat. The water temperature sensor 48 is disposed near a cooling water outlet of the fuel cell stack 10 on the cooling water circulation passage 41 to detect the temperature of the cooling water discharged from the fuel cell stack 10. The water temperature sensor 48 outputs the detected value of the cooling water temperature to the control unit 200. In some realizations, the cooling water temperature may be a stack temperature Ts that is used as the temperature of the fuel cell stack 10. It must be considered that there may be a relatively large error between the cooling water temperature and the true temperature inside the fuel cell stack 10, especially during the low-temperature start-up process.

The fuel cell stack 10 may further comprise end cell heaters 110 and 120, which may be used to heat the end cells of the stack 10 when necessary. For example, the control unit 200 may control the heaters 110 and 120 to heat the end cells of the stack 10 during low-temperature start-up, thereby aiding in increasing the temperature of the cell stack.

It will be appreciated that end cell heaters 110, 120 and the coolant heater 46 are all methods used to achieve auxiliary heating of the fuel cell stack, and the fuel cell system 100 may comprise one or both of these auxiliary heating devices, or other auxiliary heating devices.

The fuel cell system 100 may further comprise an internal stack load 80, such as a resistor, that provides a load on the stack 10 to provide current draw from the stack 10. In an example, when the fuel cell system 100 enters the low-temperature self-heating start-up mode, the load 80 may be used to draw the current generated by the stack 12 such that heat is generated inside the cell stack 12. In another realization, the fuel cell system 1 may not comprise the internal stack load 80 or a corresponding switch 82. It will be appreciated by those skilled in the art that various low-temperature self-heating modes may be applied to the technical solutions of the present disclosure. For example, self-heating by controlling the output characteristics of the cell stack, self-heating by reactant starvation, and self-heating by passing reactant gas mixture through the cell stack. In the mode of self-heating by controlling the output characteristics of the cell stack, the supply of hydrogen gas is controlled to increase the concentration polarization overpotential such that the output voltage of the cell stack decreases, thereby increasing the heat production capacity. In the mode of self-heating by reactant starvation, during reactant starvation, the electrode produces a very high overpotential, resulting in an increase in internal heat generation caused by internal resistance. In the mode of self-heating by passing reactant gas mixture into the cell stack, a small amount of fuel gas is mixed into the cathode gas supply end and supplied into the cell stack, and the energy from the catalysis of the gas mixture sent into the cathode via the catalytic layer is fully converted into heat, causing the cell stack to heat rapidly.

The fuel cell system 100 may further comprise an internal resistance measurement unit 30, for example, a high-frequency resistance (HFR) measurement unit. HFR measurements are produced by providing a high-frequency component on the electrical load of the stack 10 to produce high-frequency ripples on the current output of the stack 10. The resistance of the high-frequency component is measured by the HFR measurement unit 30. The resistance is related to and may be used to assess the moisture content in the stack 10.

A controller 20 controls the operation of the various system parts described above, thereby controlling the operation of the fuel cell system 100. For example, in the example shown in FIG. 1, the controller 20 is capable of controlling the operation of the motor 50, the compressor 52, the moisture recovery unit 56, the valves 62 and 72, the switch 82, the cooling water pump 42, the heat sink 43, the heater 46, and the three-way valves 45, and 47, thereby controlling the operation of the fuel cell system 100.

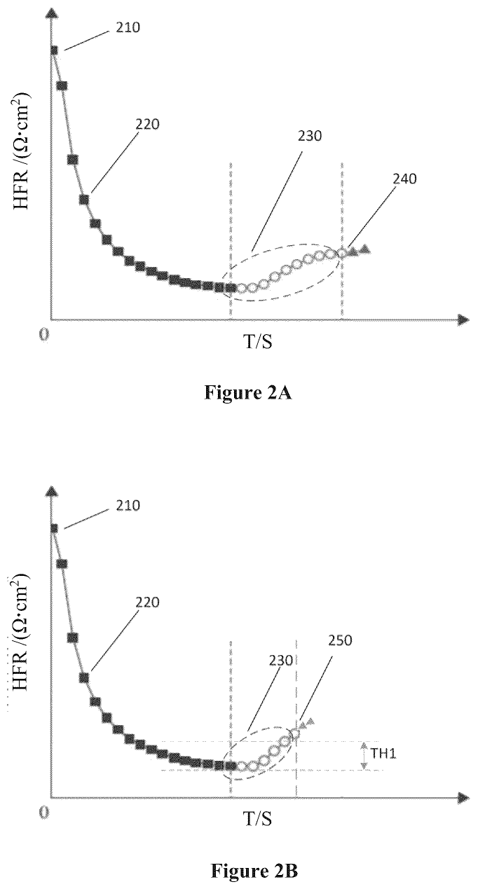

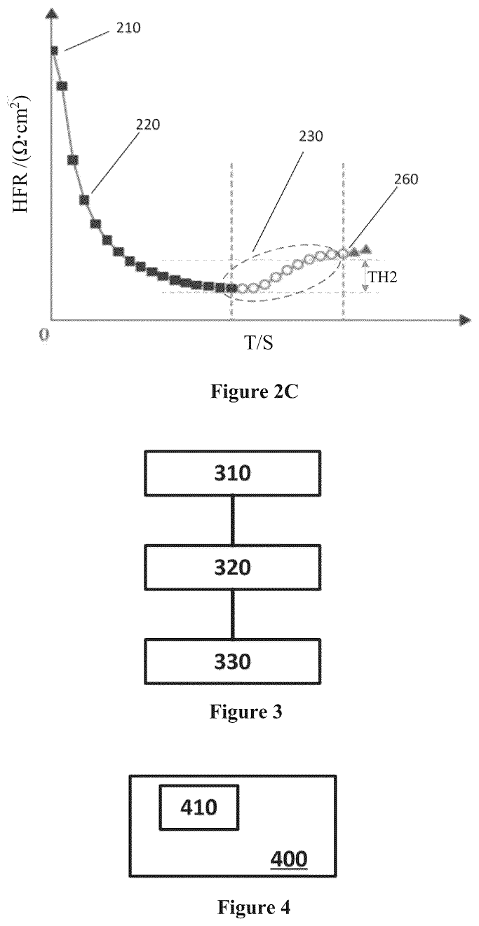

FIG. 2A shows a chart of changes in high-frequency resistance of a fuel cell stack at the start-up stage of a fuel cell system according to an example.

In an example, the cleaning of the cathodic and anodic flow channels in the fuel cell stack 10 is performed during the shutdown of the fuel cell system 100 to remove excess water therein and to provide a stack relative humidity, for example, a relative dry stack relative humidity that is suitable for the next low-temperature start-up of the fuel cell system.

As shown by numeral 210 of FIG. 2, at the start of the low-temperature start-up process, the HFR measured by the HFR measurement unit has a relatively high value, indicating that the fuel cell stack is in a relatively dry state.

As shown by numeral 220 of FIG. 2, as the electrochemical reaction produces water during the low-temperature start-up process, moisture of the proton-exchange membrane gradually increases and the hydration status of the membrane increases conductivity, thus reducing internal resistance HFR. If the internal resistance HFR decreases and equilibrates over time after the start of the low-temperature start-up process, this means that water is present in liquid form. Hence, the probability of a successful start-up is high and the system will continue the low-temperature start-up process until it enters a normal operating state.

There may be icing of the water in the cell stack during low-temperature start-up. Depending on the rate of icing and thawing in the cell stack, the amount of ice in the stack may gradually increase. As icing appears in the cell stack, the conductivity of the stack decreases and the internal resistance HFR increases. As shown by numeral 230 of FIG. 2, if the internal resistance HFR decreases, but increases upon reaching the minimum HFR, the HFR inflection point means that there is icing in the stack. At this point, the probability of failure of the current low-temperature start-up process is high, and if the current low-temperature start-up process is continued, the risk of stack damage is high.

The current low-temperature start-up process is determined to be abnormal when the control unit 20 finds an HFR inflection point upon monitoring. In an example, such as shown by numeral 240 of FIG. 2, the current low-temperature start-up process is determined to be abnormal when the control unit 20 finds an HFR inflection point upon monitoring. When the control unit 20 determines that the current low-temperature start-up process is abnormal, the current low-temperature start-up process may be halted to protect the fuel cell stack and reduce the risk of failure due to improper low-temperature start-up operations. For example, the control unit 20 may stop continuing to supply gas to the fuel cell stack 10. In an example, the control unit 20 may take steps to conduct the low-temperature start-up process. For example, the control unit 20 may re-perform the low-temperature start-up process in an external auxiliary-heating low-temperature start-up mode, the control unit may extend the working hours of the external auxiliary heating part and adjust the working temperature and the like of the external auxiliary heating part, or the control unit 20 may re-perform the self-heating low-temperature start-up process after adjusting the parameters of the self-heating low-temperature start-up mode.

It will be appreciated by those skilled in the art that although the fuel cell system 1 is described with reference to FIG. 1, in different realizations, the fuel cell system may comprise more or fewer parts, the fuel cell system in different realizations need not comprise all the parts and functions described with reference to FIG. 1, need not implement all the operations described with reference to FIG. 1, and may comprise parts and functions not shown in FIG. 1, and may implement operations not described with reference to FIG. 1.

FIG. 2B shows a chart of changes in high-frequency resistance of a fuel cell stack at the start-up stage of a fuel cell system according to an example.

The change in the HFR shown in FIG. 2B from numeral 210 to numeral 230 is similar to the process shown in FIG. 2A. Hence, it will not be repeated herein.

As shown by numerals 230 and 250 of FIG. 2B, the control unit 20 determines that the current low-temperature start-up process of the fuel cell system is abnormal when the amplitude of increase of the HFR of the fuel cell stack 10 monitored by the control unit 20 within a predetermined time period after decreasing to the minimum is greater than a first threshold TH1. If the HFR of the fuel cell stack 10 increases to more than the first threshold HT1 from the minimum within a predetermined time period, it indicates a high rate of icing in the cell stack 10, which preempts a high probability of failure of the current low-temperature start-up process, and therefore the control unit 20 determines that the current low-temperature start-up process is abnormal, accordingly. The predetermined time period may also be referred to as a time threshold. Accordingly, the control unit 20 may halt the current low-temperature start-up process and take measures accordingly to restart the low-temperature start-up process.

In an example, the control unit 20 may also determine whether the current low-temperature start-up process is abnormal based on the slope of the HFR. For example, the control unit 20 may determine that the current low-temperature start-up process is abnormal when the mean slope of the HFR is greater than a slope threshold within a predetermined time period after the slope of the HFR begins to become positive from a negative value or a zero value.

FIG. 2C shows a chart of changes in high-frequency resistance of a fuel cell stack at the start-up stage of a fuel cell system according to an example.

The change in the HFR shown in FIG. 2C from numeral 210 to numeral 230 is similar to the process shown in FIG. 2A. Hence, it will not be repeated herein.

As shown by numerals 230 and 260 of FIG. 2C, the control unit 20 determines that the current low-temperature start-up process of the fuel cell system is abnormal when the amplitude of increase of the HFR of the fuel cell stack 10 monitored by the control unit 20 after decreasing to the minimum is greater than a second threshold TH2. If the HFR of the fuel cell stack 10 increases to more than the second threshold HT from the minimum, it indicates a large quantity of ice in the cell stack 10, which preempts a high probability of failure of the current low-temperature start-up process, and therefore the control unit 20 determines that the current low-temperature start-up process is abnormal, accordingly. Accordingly, the control unit 20 may halt the current low-temperature start-up process and take measures accordingly to restart the low-temperature start-up process.

It will be appreciated by those skilled in the art that the determination conditions described with reference to FIG. 2B and FIG. 2C may be used simultaneously in one particular realization. In an example, the first threshold HT1 described with reference to FIG. 2B above may be set below the second threshold TH2 described above with reference to FIG. 2C. In this example, when the icing rate is detected to be fast based on the first threshold TH1 or in the event of any situations where a large quantity of ice is detected based on the second threshold TH2, the probability of failure of the current low-temperature start-up process is determined to be high. Hence, the control unit 20 may determine that the current low-temperature start-up process is abnormal, accordingly.

FIG. 3 shows a flow chart of a method for controlling a fuel cell system according to an example.

In step 310, a low-temperature start-up process of the fuel cell system is performed. In an example, the low-temperature start-up process of the fuel cell system is performed in a self-heating low-temperature start-up mode. In an example, the low-temperature start-up process of the fuel cell system is performed in an external auxiliary-heating low-temperature start-up mode.

The self-heating low-temperature start-up mode and the external auxiliary-heating low-temperature start-up mode are low-temperature start-up modes known in the art. The self-heating low temperature start-up mode uses the heat generated by the cell stack itself during the low-temperature start-up process to gradually raise the temperature of the cell stack to complete the low-temperature start-up process. For example, in a realization of a self-heating low temperature start-up mode, when the fuel cell system 100 enters the self-heating low temperature start-up mode, the controller 20 turns off the switch 82, for example, as shown in FIG. 1, for the load 80 to draw the current generated by the stack 12 such that heat is generated inside the cell stack 12 to heat the cell stack. Various self-heating low-temperature start-up schemes may be used in the technical solutions of the present disclosure. The external auxiliary-heating low-temperature start-up mode uses heating means outside the cell stack to aid in increasing the temperature of the cell stack. For example, the end cell heaters 110 and 120 shown in FIG. 1 may provide auxiliary heating of the cell stack to increase the temperature of the cell stack. For example, the PTC heater 46 shown in FIG. 1 may provide auxiliary heating to the cell stack by heating the coolant to increase the temperature of the cell stack. Various external auxiliary-heating low-temperature start-up schemes may be used in the technical solutions of the present disclosure. The self-heating low-temperature start-up scheme has a faster low-temperature start-up speed than the external auxiliary-heating low-temperature start-up scheme, especially in a low-temperature environment where the temperature is relatively not very low. Thus, as an embodiment, a self-heating low-temperature start-up scheme may be preferred, and when the control unit determines that the low-temperature start-up process of the self-heating low-temperature start-up scheme is abnormal, it switches to the external auxiliary-heating low-temperature start-up scheme.

In step 320, the internal resistance of the fuel cell stack in the fuel cell system is monitored. In an example, the internal resistance may be HFR of the cell stack.

In step 330, the low-temperature start-up process of the fuel cell system is determined to be abnormal based on the appearance of an inflection point in the internal resistance of the monitored fuel cell stack. In an example, the low-temperature start-up process the fuel cell system may be determined to be abnormal based on the appearance of an inflection point in the internal resistance of the fuel cell stack monitored over a predetermined time period from the start of the low-temperature start-up process. This predetermined time period may be used to assess whether the start-up of the fuel cell system is successful. In other words, if there is no abnormality during the low-temperature start-up process over this predetermined time period, it indicates that the cell system enters the normal operating state and the determination in step 330 will no longer be carried out. In an example, the low-temperature start-up process of the fuel cell system is determined to be abnormal when the internal resistance of the monitored fuel cell stack increases to a first value within a predetermined time period after decreasing to a minimum, wherein the difference between the first value and the minimum is greater than a first threshold. In an example, the low-temperature start-up process of the fuel cell system is determined to be abnormal when the internal resistance of the monitored fuel cell stack increases to a second value after decreasing to a minimum, wherein the difference between the second value and the minimum is greater than a second threshold.

In an example, the method shown in FIG. 3 may further comprise, in response to determining that the low-temperature start-up process of the fuel cell system is abnormal, halting the current low-temperature start-up process, for example, halting at least part of the operation of the current start-up process, and stop providing the fuel cell stack with gas for the electrochemical reaction, so as to avoid possible damage to the cell stack. In an example, the low-temperature start-up process of the fuel cell system may be re-performed after at least a part of the operation of the current low-temperature start-up process is halted. For example, the low-temperature start-up process of the fuel cell system may be re-performed in an external auxiliary-heating low-temperature start-up mode. For example, if the current low-temperature start-up process is in a self-heating low-temperature start-up mode, a part of the operation of the current low-temperature start-up process may be halted and the low-temperature start-up process of the fuel cell system may be re-performed in the external auxiliary-heating low-temperature start-up mode. For example, if the current low-temperature start-up process is a low-temperature start-up process in the external auxiliary-heating low-temperature mode, a part of the operation of the current low-temperature start-up process may be halted, and the low-temperature start-up process of the fuel cell system may be re-performed in the external auxiliary-heating low-temperature start-up mode, or the low-temperature start-up process of the fuel cell system may be re-performed in the external auxiliary-heating low-temperature start-up mode after adjusting the operating parameters thereof, for example, by setting a higher auxiliary heating temperature, longer auxiliary heating time, and the like.

FIG. 4 shows a block diagram of a mechanical device according to an example.

The mechanical device 400 may comprise a fuel cell system 410 that may be realized in accordance with various examples of the present disclosure, and may implement various operations and functions related to the fuel cell system described above with reference to FIGS. 1-4. In an example, the mechanical device 400 may be an automobile powered by a fuel cell.

Exemplary embodiments are described above with reference to the specific examples described in the drawings, but do not represent all examples that may be realized or fall within the protective scope of the Claims. Throughout the present Specification, the term “exemplary” means “serving as an example, instance, or illustration” and does not imply “preferred” or “advantageous” over other examples. Specific embodiments include specific details to facilitate understanding of the described technology. However, these technologies may be implemented without these specific details. In some instances, to avoid causing difficulties in understanding the concepts of the described examples, known structures and devices are shown in block diagram form.

The above description of the present disclosure is provided to allow any person skilled in the art to realize or use the present disclosure. Various modifications to the present disclosure will be apparent to those skilled in the art, and the general principles and novel features defined herein may be applied to other variations without departing from the protection scope of the present disclosure. Therefore, the present disclosure is not limited to the exemplary examples and designs described herein but is consistent with the broadest scope defined by the principles and novelty features disclosed herein.

What is claimed is:

1. A method for controlling a fuel cell system, comprising:
performing a low-temperature start-up process of the fuel cell system;
monitoring internal resistance of a fuel cell stack in the fuel cell system; and
determining that the low-temperature start-up process of the fuel cell system is abnormal based on the appearance of an inflection point in the internal resistance of the monitored fuel cell stack.

1. The method according to claim 1, wherein performing the low-temperature start-up process of the fuel cell system comprises performing the low-temperature start-up process of the fuel cell system in a self-heating low-temperature start-up mode.

2. The method according to claim 1, wherein performing the low-temperature start-up process of the fuel cell system comprises performing the low-temperature start-up process of the fuel cell system in an external auxiliary-heating low-temperature start-up mode.

3. The method according to claim 1, further comprising:
halting at least part of the operation of the current low-temperature start-up process in response to determining that the low-temperature start-up process of the fuel cell system is abnormal, and re-performing the low-temperature start-up process of the fuel cell system in the external auxiliary-heating low-temperature start-up mode.

4. The method according to claim 1, wherein determining that the low-temperature start-up process of the fuel cell system is abnormal based on the appearance of an inflection point in the internal resistance of the monitored fuel cell stack further comprises:
determining that the low-temperature start-up process of the fuel cell system is abnormal based on the appearance of an inflection point in the internal resistance of the monitored fuel cell stack within a first predetermined time period from the start of the start-up.

5. The method according to claim 1, wherein determining that the low-temperature start-up process of the fuel cell system is abnormal based on the appearance of an inflection point in the internal resistance of the monitored fuel cell stack further comprises:
determining that the low-temperature start-up process of the fuel cell system is abnormal when the internal resistance of the monitored fuel cell stack increases to a first value within a second predetermined time period after decreasing to a minimum, wherein the difference between the first value and the minimum is greater than a first threshold.

6. The method according to claim 1, wherein determining that the low-temperature start-up process of the fuel cell system is abnormal based on the appearance of an inflection point in the internal resistance of the monitored fuel cell stack further comprises:
determining that the low-temperature start-up process of the fuel cell system is abnormal when the internal resistance of the monitored fuel cell stack increases to a second value after decreasing to a minimum, wherein the difference between the second value and the minimum is greater than a second threshold.

7. The method according to claim 1, wherein the fuel cell system further comprises an internal resistance measurement unit, wherein the internal resistance of the monitored fuel cell stack is measured by the internal resistance measurement unit.

8. The method according to claim 8, wherein:
the internal resistance measurement unit is a high-frequency resistance measurement unit, and
the internal resistance of the monitored fuel cell stack is high-frequency resistance of the fuel cell stack measured by the high-frequency resistance measurement unit.

9. A device for controlling a fuel cell system comprising a control unit configured to control the operation of the fuel cell system according to the method of claim 1.

10. A fuel cell system, comprising:
a fuel cell stack;
an internal resistance measurement unit configured to measure internal resistance of the fuel cell stack; and
a control unit configured to control the operation of the fuel cell system according to the method of claim 1.

11. A mechanical device comprising the fuel cell system according to claim 11.

12. The mechanical device according to claim 12, wherein the mechanical device is an automobile.
